(19) United States
(12) Patent Application Publication
(10) Pub. No.: US 2007/0201114 A1
(43) Pub. Date: Aug. 30, 2007

(54) SOLID-STATE IMAGE SENSING DEVICE HAVING PHOTOELECTRIC CONVERSION CELLS EACH CONFIGURED BY N PIXELS IN VERTICAL DIRECTION

(76) Inventor: Yoshitaka EGAWA, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/679,339

(22) Filed: Feb. 27, 2007

(30) Foreign Application Priority Data
Feb. 28, 2006 (JP) 2006-053298

(51) Int. Cl. H04N 1/46

(52) U.S. Cl. 358/513

(57) ABSTRACT

A solid-state image sensing device includes a plurality of color filters. Each of the plurality of color filters is configured to have two pixels in a vertical direction and four pixels in a horizontal direction of a plurality of light receivers used as one unit area, a first color is arranged on first and third pixels in the horizontal direction of a first line in the vertical direction, a second color is arranged on a second pixel in the horizontal direction, a third color is arranged on a fourth pixel in the horizontal direction, the first color is arranged on first and third pixels in the horizontal direction of a second line in the vertical direction, the third color is arranged on a second pixel in the horizontal direction and the second color is arranged on a fourth pixel in the horizontal direction.

### CROSS-REFERENCE TO RELATED APPLICATIONS

This application is based upon and claims the benefit of priority from prior Japanese Patent Application No. 2006-053298, filed Feb. 28, 2006, the entire contents of which are incorporated herein by reference.

### BACKGROUND OF THE INVENTION

1. Field of the Invention

This invention relates to a solid-state image sensing device and more particularly to a complementary metal oxide semiconductor (CMOS) type color image sensor used in a mobile telephone with a camera, digital camera or video camera.

2. Description of the Related Art

Recently, in most of charge coupled device (CCD) type and CMOS type color image sensors, primary color filters which are excellent in color reproducibility are arranged in Bayer pattern. In the case of an image sensor used in a digital camera or mobile telephone, pixels with the pixel size equal to or slightly larger than 2 μm are mainly used in order to increase the number of pixels. At the development stage, pixels with the pixel size smaller than 2 μm are made public. However, if the pixel size becomes smaller, an amount of light condensed by one pixel is reduced. Therefore, a lowering in the sensitivity becomes significant and the image quality at low illumination is greatly degraded.

In order to compensate for the lowering in the sensitivity of the minute pixels, one output circuit is arranged for every two photodiodes (PD) in the vertical direction. Thus, a method for substantially increasing the area (pixel size) of the photodiode by making the so-called vertical-2-pixel/one-cell structure in which two photodiodes are commonly used is already proposed (for example, refer to Jpn. Pat. Appln. KOKAI Publication No. H10-150182).

As a sensor module for the mobile telephone, a small module with an optical lens which is short is required to be developed as the telephone is made thinner. In the case of the small module, light emitted from the optical lens is made incident on the photodiodes in the oblique direction in the pixel area, particularly, in the peripheral portion thereof. In order to cope with the light incident in the oblique direction, for example, a light shielding film of aluminum (Al), color filter and micro-lens are conventionally arranged in positions deviated from directly above the photodiodes in the direction of the incident light.

However, if the vertical-2-pixel/one-cell structure is made, the photodiodes cannot be arranged at uniform intervals because the separation state between the photodiodes becomes non-uniform, for example. Therefore, when the incident angle of light becomes equal to 20 degrees or more, part of light incident on one of the photodiodes of each cell which lies nearer to the upper portion or lower portion of the pixel area is shielded by a read gate. Then, a light amount which can be condensed is further reduced and, as a result, the signal amount in the photodiode is reduced. A reduction in the signal amount of a specified photodiode causes occurrence of coloring or generation of lateral lines on the output screen.

Particularly, in the case of minute pixels, coloring tends to occur in the upper portion or lower portion of the output screen due to the influence by fluctuation in the manufacturing process. That is, the positional deviation of the micro-lens, light shielding film or read gate greatly influences on generation of coloring.

In the case of a sensor module mounted on the mobile telephone, the optical lens is generally formed of an inexpensive material. Therefore, coloring tends to occur in the upper portion or lower portion of the output screen due to chromatic aberration of the optical lens even in the one-pixel-one-cell structure in which the photodiodes are not commonly used.

### BRIEF SUMMARY OF THE INVENTION

According to a first aspect of the present invention, there is provided a solid-state image sensing device comprising a plurality of light receivers two-dimensionally arranged on a semiconductor substrate and each used as a single pixel; a plurality of condensers respectively arranged above the plurality of light receivers; a plurality of color filters arranged between the plurality of light receivers and the plurality of condensers, the plurality of color filters being configured to have two pixels in a vertical direction and four pixels in a horizontal direction of the plurality of light receivers used as one unit area, a first color being arranged on first and third pixels in the horizontal direction, a second color being arranged on a second pixel of the horizontal direction, a third color being arranged on a fourth pixel in the horizontal direction of a first line in the vertical direction, the first color being arranged on first and third pixels in the horizontal direction, the third color being arranged on a second pixel in the horizontal direction and the second color being arranged on a fourth pixel in the horizontal direction of a second line thereof in the vertical direction; and a signal processor which generates one horizontal video signal based on output signals of 2n (n is a natural number) lines in the vertical direction read by the plurality of light receivers.

### BRIEF DESCRIPTION OF THE SEVERAL VIEWS OF THE DRAWING

FIG. 1 is a block diagram showing an example of the configuration of a one-chip camera according to a first embodiment of this invention.

FIG. 2 is a circuit diagram showing one example of a pixel area of a solid-state image sensing device of the one-chip camera shown in FIG. 1.

FIG. 3 is a cross-sectional view showing an example of the structure of the solid-state image sensing device shown in FIG. 2.

FIG. 4 is a plan view showing an example of the structure of the solid-state image sensing device.

FIG. 5 is a plan view showing another example of the structure of the solid-state image sensing device.

FIG. 6 is a diagram for illustrating the process of a color separation circuit in a signal processor of the one-chip camera shown in FIG. 1.

FIG. 7 is a block diagram showing an example of the configuration of a one-chip camera according to a second embodiment of this invention.

FIG. 8 is a block diagram showing an example of the configuration of a one-chip camera according to a third embodiment of this invention.

FIG. 9 is a block diagram showing an example of the configuration of a one-chip camera according to a fourth embodiment of this invention.

FIG. 10 is a block diagram showing an example of the configuration of a one-chip camera according to a fifth embodiment of this invention.

FIG. 11 is a block diagram showing an example of the configuration of a one-chip camera according to a sixth embodiment of this invention.

FIG. 12 is a circuit diagram showing another example of the pixel area of the solid-state image sensing device of the one-chip camera shown in FIG. 1.

### DETAILED DESCRIPTION OF THE INVENTION

Embodiments of the present invention will be described with reference to the accompanying drawings. It should be noted that the drawings are schematic ones and the dimension ratios shown therein are different from the actual ones. The dimensions vary from drawing to drawing and so do the ratios of dimensions. The following embodiments are directed to a device and a method for embodying the technical concept of the present invention and the technical concept does not specify the material, shape, structure or configuration of components of the present invention. Various changes and modifications can be made to the technical concept without departing from the scope of the claimed invention.

### First Embodiment

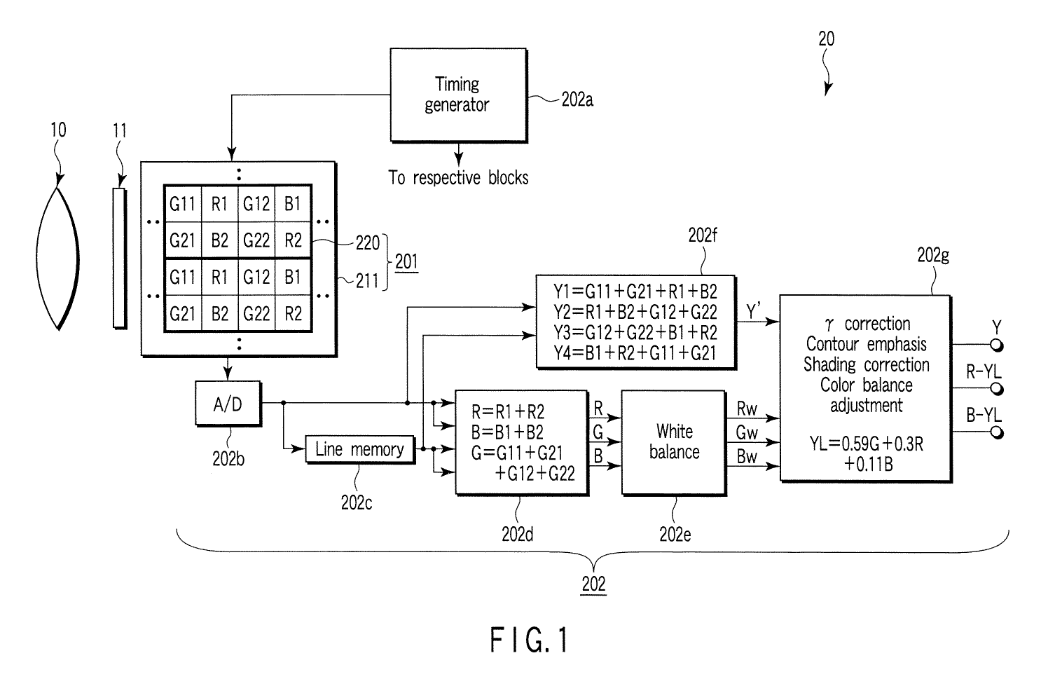

FIG. 1 shows the basic configuration of a one-chip camera such as a digital camera or video camera using a CMOS type color image sensor (solid-state image sensing device) according to a first embodiment of this invention. In this example, a case wherein primary color filters of red (R), green (G) and blue (B) are used as color filters is explained.

As shown in FIG. 1, the one-chip camera includes an optical lens (image sensing optical system) 10, infrared-cut filter 11 and amplification type CMOS color image sensor 20. The infrared-cut filter 11 is used to cut or omit infrared light contained in light emitted from the optical lens 10.

The image sensor 20 is configured by a solid-state image sensing device 201 and signal processor 202 mounted on one chip, for example. On a pixel area 211 of the solid-state image sensing device 201, a plurality of color filters 220 of three primary colors are arranged in a two-dimensional form. Each of the color filters 220 has the size corresponding to eight pixels in total including two pixels in the vertical (row) direction x four pixels in the horizontal (column) direction used as one unit. In the case of the present embodiment, for example, G11 and G12 filters of a first color are respectively arranged on the first and third pixels in the horizontal direction of a first line of the color filter 220 in the vertical direction, an R1 filter of a second color is arranged on the second pixel in the horizontal direction and a B1 filter of a third color is arranged on the fourth pixel in the horizontal direction. Further, for example, G21 and G22 filters of the first color are respectively arranged on the first and third pixels in the horizontal direction of a second line of the color filter 220 in the vertical direction, a B2 filter of the third color is arranged on the second pixel in the horizontal direction and an R2 filter of the second color is arranged on the fourth pixel in the horizontal direction. In the present embodiment, one photodiode (light receiver) is used as one pixel (single pixel). Further, the R1 filter, B1 filter and the B2 filter and R2 filter can be replaced in positions.

The color filters 220 with the above array are repeatedly arranged for each unit on the pixel area 211 (the arrangement is called the G stripe/RB complete checkered arrangement). That is, the G11, G21 filters and G12, G22 filters are arranged in a vertical stripe form on the first, third, . . . pixels in the horizontal direction. Further, the R1, R2 filters and the B1, B2 filters are alternately arranged on the second, fourth, . . . pixels in the horizontal direction.

The signal processor 202 includes a block of a timing generator 202a, a block of an analog-to-digital conversion circuit (which is hereinafter referred to as an analog-to-digital converter) 202b, a block of a line memory 202c, a block of a color separation circuit 202d, a block of a white balance circuit 202e, a block of a luminance signal processing circuit 202f and a block of a color signal processing circuit 202g.

The timing generator 202a generates a pulse to operate the pixel area 211 of the solid-state image sensing device 201. Further, the timing generator 202a supplies pulses required for the operations of the other blocks to the respective blocks. The analog-to-digital converter 202b digitizes an output of the solid-state image sensing device 201. The line memory 202c holds a digital output signal from the analog-to-digital converter 202b for each line. The color separation circuit 202d adds signals of two lines together to generate R, G and B signals (one horizontal video signal) which are well known in the art. The white balance circuit 202e adjusts the levels of the R, G and B signals and performs a known white balance process (generation of signals Rw, Gw, Bw). The luminance signal processing circuit 202f generates a luminance control signal Y′ by use of signals of two lines by a known method. The color signal processing circuit 202g performs known processes such as a y correction process, contour emphasizing process, lens shading process and color balance adjusting process based on the white balance processing signals Rw, Gw, Bw and luminance control signal Y′ to generate a Y signal (luminance signal), R-YL signal and B-YL signal.

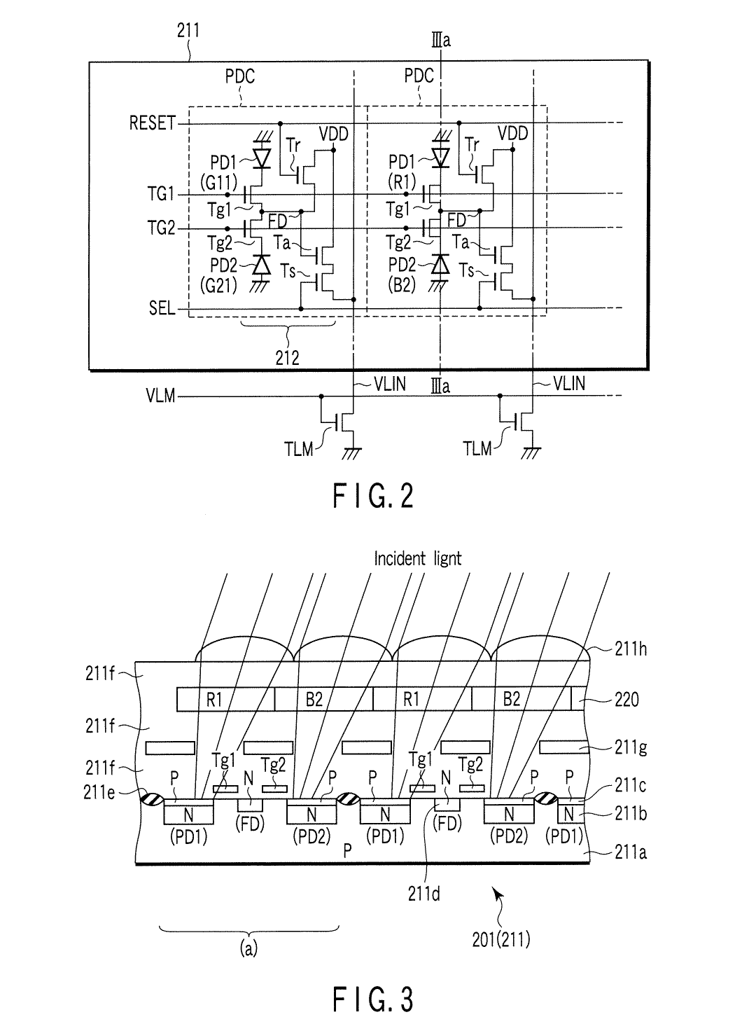

Next, the configuration of the solid-state image sensing device 201 is explained in detail. FIG. 2 shows the basic configuration of the pixel area 211. In the pixel area 211, a plurality of photoelectric conversion cells PDC are arranged in a two-dimensional form. In the case of the present embodiment, for example, as shown in FIG. 2, each photoelectric conversion cell PDC has a vertical-2-pixel/one-cell structure. That is, each amplification circuit (output circuit) 212 is arranged for every two photodiodes PD1, PD2 in the vertical direction among the plurality of photodiodes PDn (n is a natural number) arranged in a two-dimensional form to configure one photoelectric conversion cell PDC. The area of the photodiodes can be substantially increased by use of the vertical-2-pixel/one-cell structure and degradation in the sensitivity of the fine pixel can be suppressed.

The amplification circuit 212 includes five transistors, for example, an output amplifying transistor Ta, selection switching transistor Ts, reset transistor Tr and signal charge read gate transistors Tg1, Tg2. In short, each photoelectric conversion cell PDC includes the five transistors Ta, Ts, Tr, Tg1, Tg2 configuring the amplification circuit 212 and two photodiodes PD1, PD2. For example, the anodes of the photodiodes PD, PD2 are grounded. The cathodes of the photodiodes PD1, PD2 are respectively connected o the sources of the transistors Tg1, Tg2. Pulses TG1, TG2 are respectively applied to the gates (TG gates) of the transistors Tg1, Tg2. The drains of the transistors Tg1, Tg2 are commonly connected to the gate of the transistor Ta and the drain of the transistor Tr. The common connection node is used as a detector FD. Further, a pulse RESET is supplied to the gate of the transistor Tr and power supply voltage VDD is applied to the source thereof. The drain of the transistor Ta is connected to the drain of the transistor Ts and the source thereof is applied with the power supply voltage VDD. The source of the transistor Ts is connected to a vertical signal line VLIN and a pulse SEL is supplied to the gate thereof.

In the lower portion (or upper portion) of the pixel area 211, load transistors TLM for source follower circuits are arranged side by side in the horizontal direction. The drains of the load transistors TLM are connected to the vertical signal line VLIN and the sources thereof are grounded. Further, voltage VLM (for example, 1V) used to control a constant amount of current flowing through the vertical signal line VLIN is commonly applied to the gates of the load transistors TLM.

Next, the read operation of signal charges with the above configuration is explained below. First, the pulse SEL is set in the on state to set a preset source follower circuit formed of the transistor Ts and load transistor TLM into an operative state. After signal charges obtained by photoelectric conversion are stored in the photodiodes PD1 in a preset period of time, the pulse RESET is set in the on state to eliminate a noise signal such as dark current of the detector FD before reading the stored signal charges. As a result, the potential of the detector FD is set to the power supply voltage VDD (for example, 2.8V). At this time, voltage (reset level) obtained when no signal is present in the detector FD and used as a reference is output to the vertical signal line VLIN. In this state, the transistor Tg1 is turned on by activating the pulse TG1 at the first read line time. Thus, the signal charges stored in the photodiode PD1 are read into the detector FD. Likewise, the transistor Tg2 is turned on by activating the pulse TG2 at the next read line time. Thus, the signal charges stored in the photodiode PD2 are read into the detector FD. Then, voltage (signal charges+reset level) of the detector FD is read and supplied to the vertical signal line VLIN. The reset level can be eliminated by deriving a different with respect to the former reset level. The above operation is called a noise reduction processing operation (correlated double sampling [CDS]).

FIG. 3 shows the cross-sectional structure of the solid-state image sensing device 201. A portion indicated by (a) of FIG. 3 approximately corresponds to the cross section (one photoelectric conversion cell PDC) taken along the IIIa-IIIa line of FIG. 2. In this example, the peripheral portion (particularly, the upper portion on which light from the optical lens 10 is made incident in the oblique direction) of the pixel area 211 is shown.

As shown in FIG. 3, a plurality of photodiodes PDn formed of N-type diffusion layers 211b are formed on the surface of a P-type semiconductor substrate 211a (in this example, a plurality of photodiodes PD1, PD2 are alternately and discontinuously arranged). Shield layers 211c formed of P-type diffusion layers to prevent generation of leak current are respectively formed on the upper surfaces of the plurality of photodiodes PD1, PD2. Further, N-type diffusion layers 211d used as the detectors FD which convert signal charges to voltages are each formed on the surface of the P-type semiconductor substrate 211a in position between the photodiodes PD1 and PD2 configuring the photoelectric conversion cell PDC. The N-type diffusion layer 211d is arranged at a preset distance from the photodiodes PD1 and PD2. Further, the TG gates of the signal charge read transistors Tg1 are arranged above the surface of the P-type semiconductor substrate 211a in positions between the photodiodes PD1 and the detectors FD with insulating films (not shown) disposed therebetween. Likewise, the TG gates of the signal charge read transistors Tg2 are arranged above the surface of the P-type semiconductor substrate 211a in positions between the photodiodes PD2 and the detectors FD with insulating films (not shown) disposed therebetween. Further, element isolation insulating films (for example, LOCOS oxide films) 211e are formed on the surface of the P-type semiconductor substrate 211a in positions between the photodiodes PD2 and the photodiodes PD1 of the adjacent photoelectric conversion cells PDC.

A plurality of light shielding films (for example, Al films) 211g which control incident of light are formed above the surface of the P-type semiconductor substrate 211a while part of a smoothing layer 211f which absorbs the step difference on the surface is disposed therebetween. The light shielding films 211g are also used as wirings to supply the power supply voltage VDD. A plurality of color filters 220 are continuously arranged above the light shielding films 211g with another part of the smoothing layer 211f disposed therebetween. A plurality of micro-lenses (condensers) 211h are continuously arranged above the color filters 220 while the remaining part of the smoothing layer 211f used to improve a difference in the thickness of the color filters 220 is disposed therebetween. The micro-lens 211h is formed to efficiently condense light (incident light from the optical lens 10) incident on the pixel area 211 onto the photodiodes PD1, PD2.

Light emitted from the optical lens 10 is made obliquely incident on the photodiodes PD1, PD2 in the pixel area 211, particularly, in the peripheral portion thereof. In order to cope with the obliquely incident light, the light shielding films 211g, color filters 220 and micro-lenses 211h are arranged in positions slightly shifted in the direction of the incident light from directly above the photodiodes PD1, PD2.

According to the configuration of the present embodiment, projecting portions can be formed on the TG gates of the signal charge read transistors Tg1, Tg2 of the pixel area 211.

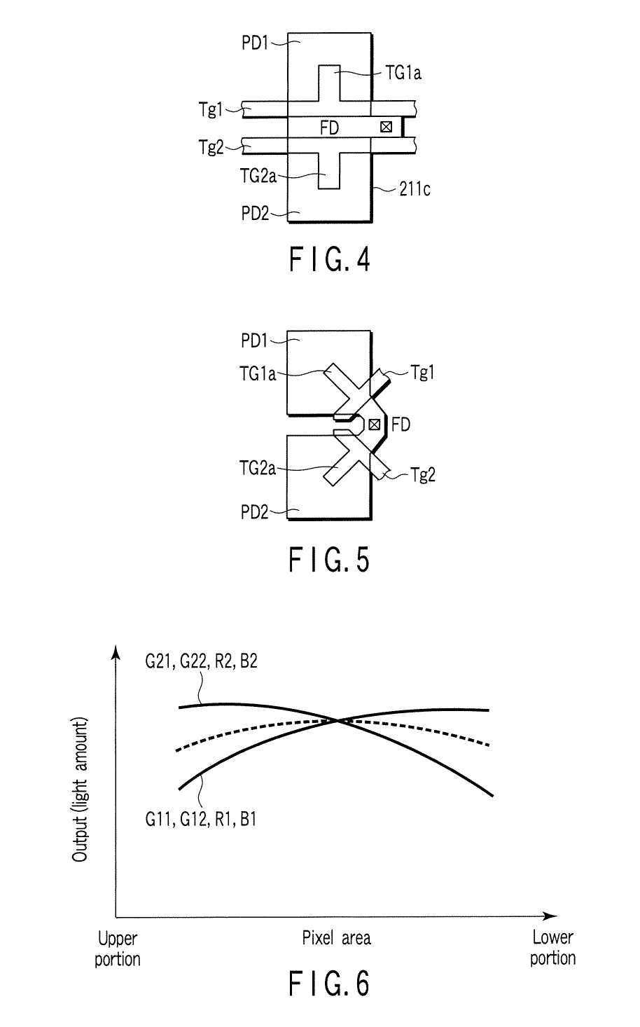

FIG. 4 shows an example of the configuration of the photoelectric conversion cell PDC in the pixel area 211. In this example, part of the structure is shown to be made transparent. In the case of the present embodiment, since the vertical-2-pixel/one-cell structure is used, the structure is made so as to read signal charges from the photodiodes PD1, PD2 in the upper and lower directions (vertical direction) with the detector FD set at the center. That is, the TG gates of the signal charge read transistors tg1, Tg2 are arranged in parallel in the horizontal direction between the two photodiodes PD1 and PD2 adjacent in the vertical direction. The detector FD is arranged between the TG gates.

Part (TG1a) of the TG gate of the transistor Tg1 is formed in a projecting form and arranged to extend to substantially the center of the condensing area of the photodiode PD1. Likewise, part (TG2a) of the TG gate of the transistor Tg2 is formed in a projecting form and arranged to extend to substantially the center of the condensing area of the photodiode PD2. With the above structure, signal charges stored in the photodiodes PD1, PD2 can be more easily read. Further, the photodiodes PD1, PD2 can be formed deeper and saturated charge amounts can be increased.

FIG. 5 shows another example of the configuration of the photoelectric conversion cell PDC in the pixel area 211. As shown in this example, for example, the TG gates of the signal charge read transistors Tg1, Tg2 can be arranged obliquely with respect to the two photodiodes PD1, PD2 adjacent in the vertical direction to reduce the capacitance (area) of the detector FD. With this arrangement, the charge-voltage conversion gain can be enhanced and an influence of noises in the succeeding-stage signal processor 202 can be reduced. Further, when parts (TG1a, TG2a) of the TG gates formed with the projecting portions to extend to substantially the central portions of the condensing areas of the photodiodes PD1, PD2, signal charges stored in the photodiodes PD1, PD2 can be more easily read.

Next, the operation of the above configuration associated with signal processing in a one-chip camera is explained below. For example, as shown in FIG. 1, light emitted from the optical lens 10 is made incident on the pixel area 211 of the solid-state image sensing device 201 via the infrared-cut filter 11. In the pixel area 211, lights passing through the color filters 220 are subjected to the photoelectric conversion process by the corresponding photodiodes PD1, PD2. An output signal of the solid-state image sensing device 201 is digitized by the analog-to-digital converter 202b. The digital output signal is input to the line memory 202c and input to the color separation circuit 202d and luminance signal processing circuit 202f in parallel with a next line signal.

In the color separation circuit 202d, signals of two lines are added together to form one horizontal video signal (signals of R, G and B). That is, in the case of the present embodiment, an R signal is generated by adding together an R1 signal of the first line and an R2 signal of the second line, a B signal is generated by adding together a B1 signal of the first line and a B2 signal of the second line and a G signal is generated by adding together G11, G12 signals of the first line and G21, G22 signals of the second line. As a result, for example, as shown by broken lines in FIG. 6, a signal difference between the lines of the respective signals of R, G and B can be suppressed even if a signal difference (sensitivity difference) occurs between the odd-numbered line and the even-numbered line of the photodiodes PD1, PD2 in the peripheral portion of the pixel area 211, particularly, in the upper portion (or lower portion) thereof.

In the white balance circuit 202e shown in FIG. 1, a normal color signal process, for example, a white balance process to equally set the levels of the signals R, G and B is performed to generate white balance processing signals Rw, Gw, Bw.

In the luminance signal processing circuit 202f, signals of two lines are sequentially added for every four pixels of area with two pixels in the vertical direction and two pixels in the horizontal direction and a luminance control signal Y′ is finally generated. That is, in the case of the present embodiment, added signals Y1, Y2, Y3, Y4 are calculated by repeatedly performing the adding operations (arithmetic operations of G+G+R+B) of the signals while one pixel is horizontally shifted at one time. For example, the added signal Y1 is calculated by performing the adding operation (G11+G21+R1+B2) of the signals, the added signal Y2 is calculated by performing the adding operation (R1+B2+G12+G22) of the signals, the added signal Y3 is calculated by performing the adding operation (G12+G22+B1+R2) of the signals and the added signal Y4 is calculated by performing the adding operation (B1+R2+G11+G21) of the signals. Then, the luminance control signal Y′ is generated based on the added signals Y1, Y2, Y3, Y4.

When a single-color subject such as a red or blue subject is photographed, a vertical stripe occurs in some cases by an added signal level difference between the signals of the column of R1, B2 in the vertical direction and the signals of the column of B1, R2. Occurrence of the vertical stripe can be suppressed by use of a method for performing the adding process of sequentially adding the signals of two lines for every eight pixels of area with two pixels in the vertical direction and four pixels in the horizontal direction.

In the color signal processing circuit 202g, processes such as a y correction process, contour emphasizing process, lens shading correction process and color balance adjusting process are performed based on the luminance control signal Y′ from the luminance signal processing circuit 202f and the white balance processing signals Rw, Gw, Bw from the white balance circuit 202e. Then, a luminance signal Y, R-YL signal and B-LY signal required for forming an output screen image are generated from the color signal processing circuit 202g.

As described above, an optimum on-chip color filter array can be provided with respect to the cell layout in which a plurality of pixels in the vertical direction of the image sensor are commonly used. That is, in the 3-color filter having eight pixels of two pixels in the vertical direction and four pixels in the horizontal direction as one unit area and used as the color filter array, the first color is treated as a stripe on each vertical column and the second and third colors are alternately arranged while they are shifted on the first and second lines (so-called complete checkered arrangement). Then, one horizontal video signal of R, G and B is calculated by adding together the photoelectric conversion output signals of two lines by the digital process. As a result, occurrence of the signal difference between the lines of the signals of R, G and B can be suppressed even if the signal difference occurs between the odd-numbered line and the even-numbered line. Therefore, occurrence of coloring on the output screen can be suppressed and a high-quality image can be achieved.

In the present embodiment, the photoelectric conversion cell PDC is formed with the vertical-2-pixel/one-cell structure. Therefore, as shown in FIG. 3, for example, the separation states (pitches) between the respective photodiodes PD1 and PD2 become different. That is, in the case of the vertical-2-pixel/one-cell structure, a plurality of photodiodes PD1, PD2 cannot be arranged at equal intervals. Therefore, at least part of the incident light is shielded by the TG gate depending on the incident angle of light with respect to the photodiodes PD1, PD2. For example, when the incident angle of light to the photodiodes PD1, PD2 becomes 20 degrees or more, the incident light is partly shielded by one of the TG gates of each cell (in the example of FIG. 3, the TG gate on the transistor Tg1 side). Thus, since an amount of incident light to the photodiode PD1 is reduced, a signal amount (charge amount) in the photodiode PD1 is reduced. Then, a signal amount of R1 is reduced in total. In contrast, since the incident light is not shielded by the TG gate in the photodiode PD2 lying adjacent to the above photodiode, a signal amount of B2 is not reduced. The above phenomenon becomes significant in the peripheral portion of the pixel area 211, particularly, in the upper portion or lower portion of the pixel area 211 in the case of the vertical-2-pixel/one-cell structure.

In this case, an amount of the B signal becomes larger in the upper portion of the pixel area 211 and the output screen becomes bluish even if the signal amounts of R, G and B in a portion near the central portion of the pixel area 211 are adjusted and set to the same value by use of the white balance circuit 202e to generate “white”. On the other hand, an amount of the R signal becomes larger in the lower portion of the pixel area 211 and the output screen becomes reddish. Further, since the signal amounts each of the G line are different each of the upper portion and lower portion in the pixel area 211, lateral lines occurs.

According to the present embodiment, the above problem can be solved. That is, a signal amount difference between the lines of the signals of R, G and B can be suppressed. As a result, even when an amount of incident light on one of the photodiodes is reduced, it is possible to prevent the output screen from becoming bluish or reddish or a lateral line from occurring.

Particularly, as shown in FIG. 4 or FIG. 5, when parts (TG1a, TG2a) of the TG gates are formed to extend to portions near the central portions of the condensing areas of the photodiodes PD1, PD2, at least part of the incident light (on the condensing area) is shielded by the TG gate irrespective of the incident angle of light and thus a signal amount is reduced. With the above structure, a signal amount difference between the lines of the signals of R, G and B can be suppressed and a problem that the output screen becomes bluish or reddish or a lateral line occurs can be solved.

The problem is not limited to coloring caused by a signal amount difference in the peripheral portion of the pixel area 211 and the problem of coloring due to the positional deviation (fluctuation in the manufacturing process) of the micro-lenses, light shielding films, TG gates and the like can also be solved.

In the above embodiment, an effective space sampling point after the adding process of adding the signals of R, B and the signal of G is deviated when the process in the color separation circuit 202d is performed. That is, since the signal R becomes (R1+R2), the effective space sampling point thereof is set in the intermediate position between the R1 filter and the R2 filter (at the contact point between the G12 filter and the G22 filter on the color filter 220). Likewise, since the signal B becomes (B1+B2), the effective space sampling point thereof is set in the intermediate position between the B1 filter and the B2 filter (at the contact point between the G12 filter and the G22 filter on the color filter 220). On the other hand, since the signal G becomes (G11+G21+G12+G22), the effective space sampling point thereof is set in the intermediate position between the G11 filter and the G22 filter and in the intermediate position between the G21 filter and the G12 filter (at the contact point between the R1 filter and the B2 filter on the color filter 220). In this case, for example, signals (G11′+G21′) of G on the first column of the color filter 220 adjacent on the right side are additionally added for calculation of the G signal to derive (G11+G21+G12+G22+G11′+G21′) (addition of six pixels in total area with two pixels in the vertical direction and three pixels in the horizontal direction). Thus, the effective space sampling point of the G signal can be set to the effective space sampling points of the R, B signals.

### Second Embodiment

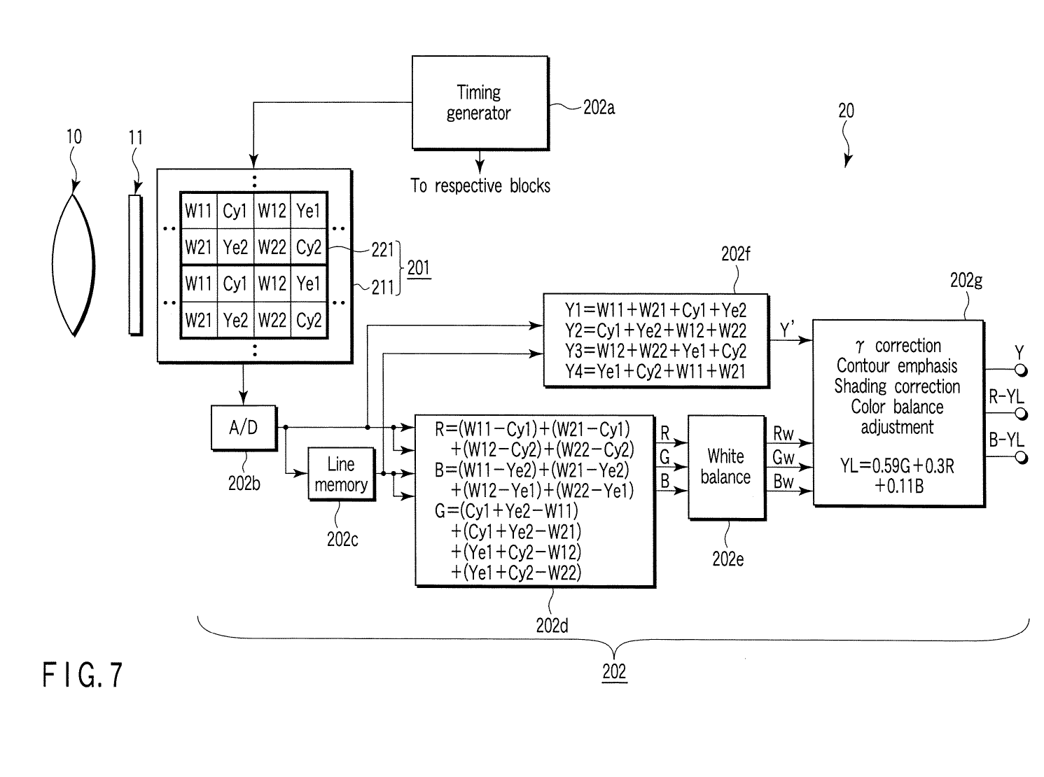

FIG. 7 showing the basic configuration of a one-chip camera using a CMOS type color image sensor (solid-state image sensing device) according to a second embodiment of this invention. In this example, a case wherein the photoelectric conversion cell is formed with the vertical-2-pixel/one-cell structure and a complementary color filter of white/transparent (W), cyan (Cy), yellow (Ye) is used as a color filter is explained. Portions which are the same as those of FIG. 1 are denoted by the same reference symbols and the detail explanation thereof is omitted.

As shown in FIG. 7, in the present embodiment, the array of a color filter 221 is formed in a W-stripe/CyYe complete checkered form having the area corresponding to eight pixels of W, Cy, Ye in total area with two pixels in the vertical (row) direction and four pixels in the horizontal (column) direction. That is, in the case of the present embodiment, for example, W11 and W12 filters of a first color are respectively arranged on the first and third pixels in the horizontal direction of a first line of the color filter 221 in the vertical direction, a Cy1 filter of a second color is arranged on the second pixel in the horizontal direction and a Ye1 filter of a third color is arranged on the fourth pixel in the horizontal direction. Further, for example, W21 and W22 filters of the first color are respectively arranged on the first and third pixels in the horizontal direction of a second line thereof in the vertical direction, a Ye2 filter of the third color is arranged on the second pixel in the horizontal direction and a Cy2 filter of the second color is arranged on the fourth pixel in the horizontal direction. The color filters 221 with the above array are repeatedly arranged for each unit on the pixel area 211. In this case, the Cy1 filter, Ye1 filter and the Ye2 filter, Cy2 filter may be replaced in positions.

In a color separation circuit 202d of a signal processor 202, signals of two lines are added together to generate one horizontal video signal (R, G and B signals). That is, in the case of the present embodiment, an R (R1) signal is generated by adding signals of (W11−Cy1)+(W21−Cy1) and (W12−Cy2)+(W22−Cy2), a B signal is generated by adding signals of (W11−Ye1)+(W21−Ye2) and (W12−Ye1)+(W22−Ye1) and a G signal is generated by adding signals of (Cy1+Ye2−W11), (Cy1+Ye2−W21), (Ye1+Cy2−W12) and (Ye1+Cy2−W22). Thus, a signal difference between the lines of the respective signals of R, G and B can be suppressed even if a signal difference (sensitivity difference) occurs between the odd-numbered line and the even-numbered line of the photodiodes PD1, PD2, particularly, in the upper portion (or lower portion) of the pixel area 211.

In a luminance signal processing circuit 202f, signals of two lines are sequentially added for every four pixels of two pixels in the vertical direction x two pixels in the horizontal direction and a luminance control signal Y′ is finally generated. That is, in the case of the present embodiment, added signals Y1, Y2, Y3, Y4 are calculated by repeatedly performing the adding operations (arithmetic operations of W+W+Cy+Ye) of the signals while one pixel is horizontally shifted at one time. For example, the added signal Y1 is calculated by performing the adding operation (W11+W21+Cy1+Ye2) of the signals, the added signal Y2 is calculated by performing the adding operation (Cy1+Ye2+W12+W22) of the signals, the added signal Y3 is calculated by performing the adding operation (W12+W22+Ye1+Cy2) of the signals and the added signal Y4 is calculated by performing the adding operation (Ye1+Cy2+W11+W21) of the signals. Then, the luminance control signal Y′ is generated based on the added signals Y1, Y2, Y3, Y4.

Like the case of the first embodiment, when the above color filter 221 is used, a signal difference between the lines of the respective signals of R, G and B can be suppressed even if a signal difference (sensitivity difference) occurs between the odd-numbered line and the even-numbered line of the photodiodes PD1, PD2, particularly, in the upper portion (or lower portion) of the pixel area 211. Thus, occurrence of coloring on the output screen can be suppressed and a high-quality image can be achieved.

In addition, when the color filter 221 is used, an RB signal which is twice the RB signal and a luminance signal which is 2.5 times the luminance signal when the color filter 220 of the primary colors is used can be obtained. As a result, the sensitivity can be enhanced.

### Third Embodiment

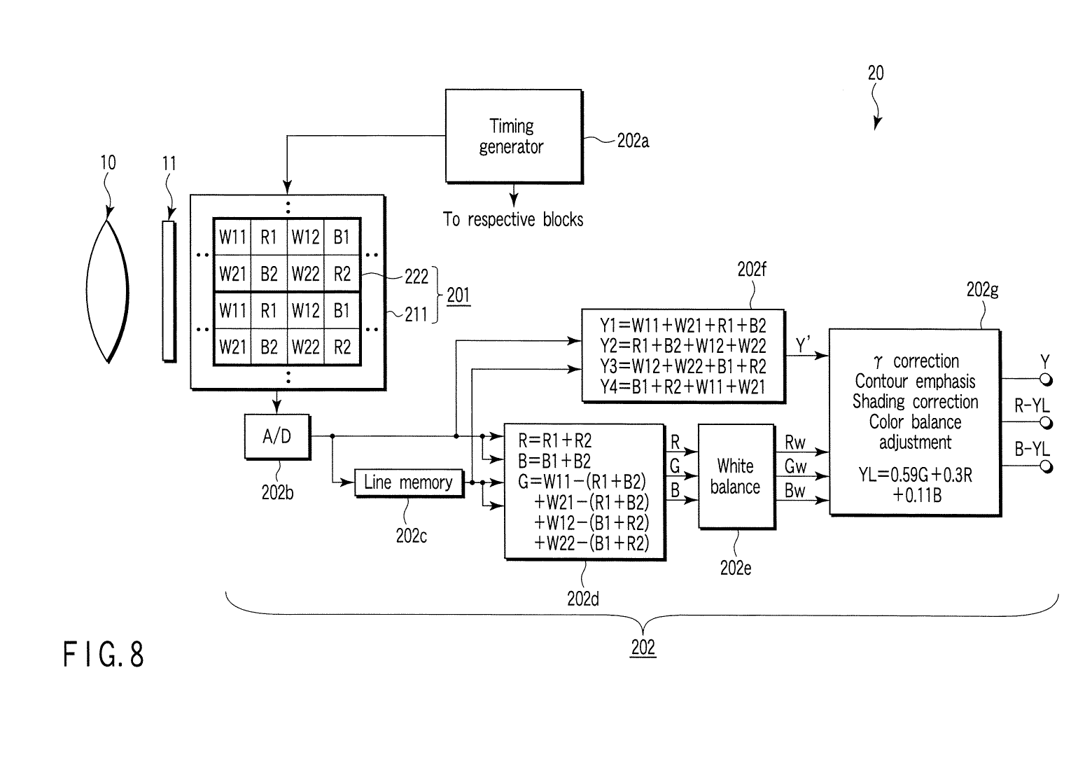

FIG. 8 shows the basic configuration of a one-chip camera using a CMOS type color image sensor (solid-state image sensing device) according to a third embodiment of this invention. In this example, a case wherein a photoelectric conversion cell is formed with the vertical-2-pixel/one-cell structure and a color filter of white/transparent (W), red (R), blue (B) is used as a color filter is explained. Portions which are the same as those of FIG. 1 are denoted by the same reference symbols and the detail explanation thereof is omitted.

As shown in FIG. 8, in the present embodiment, the array of a color filter 222 is formed in a W-stripe/RB complete checkered form having the size corresponding to eight pixels of W, R, B in total including two pixels in the vertical (row) direction x four pixels in the horizontal (column) direction. That is, in the case of the present embodiment, for example, W11 and W12 filters of a first color are respectively arranged on the first and third pixels in the horizontal direction of a first line of the color filter 222 in the vertical direction, an R1 filter of a second color is arranged on the second pixel in the horizontal direction and a B1 filter of a third color is arranged on the fourth pixel in the horizontal direction. Further, for example, W21 and W22 filters of the first color are respectively arranged on the first and third pixels in the horizontal direction of a second line thereof in the vertical direction, a B2 filter of the third color is arranged on the second pixel in the horizontal direction and an R2 filter of the second color is arranged on the fourth pixel in the horizontal direction. The color filters 222 with the above array are repeatedly arranged for each unit on the pixel area 211. In this case, the R1 filter, B1 filter and the B2 filter, R2 filter may be replaced in positions.

In a color separation circuit 202d of a signal processor 202, signals of two lines are added together to generate one horizontal video signal (R, G and B signals). That is, in the case of the present embodiment, an R signal is generated by adding an R1 signal and R2 signal, a B signal is generated by adding a B1 signal and B2 signal and a G signal is generated by adding signals of (W11−(R1+B2)), (W21−(R1+B2)), (W12−(B1+R2)) and (W22−(B1+R2)). Thus, a signal difference between the lines of the respective signals of R, G and B can be suppressed even if a signal difference (sensitivity difference) occurs between the odd-numbered line and the even-numbered line of the photodiodes PD1, PD2, particularly, in the upper portion (or lower portion) of the pixel area 211.

In a luminance signal processing circuit 202f, signals of two lines are sequentially added for every four pixels of area with two pixels in the vertical direction and two pixels in the horizontal direction and a luminance control signal Y′ is finally generated. That is, in the case of the present embodiment, added signals Y1, Y2, Y3, Y4 are calculated by repeatedly performing the adding operations (arithmetic operations of W+W+R+B) of the signals while one pixel is horizontally shifted at one time. For example, the added signal Y1 is calculated by performing the adding operation (W11+W21+R1+B2) of the signals, the added signal Y2 is calculated by performing the adding operation (R1+B2+W12+W22) of the signals, the added signal Y3 is calculated by performing the adding operation (W12+W22+B1+R2) of the signals and the added signal Y4 is calculated by performing the adding operation (B1+R2+W11+W21) of the signals. Then, the luminance control signal Y′ is generated based on the added signals Y1, Y2, Y3, Y4.

Like the case of the first embodiment, when the above color filter 222 is used, a signal difference between the lines of the respective signals of R, G and B can be suppressed even if a signal difference (sensitivity difference) occurs between the odd-numbered line and the even-numbered line of the photodiodes PD1, PD2, particularly, in the upper portion (or lower portion) of the pixel area 211. Thus, occurrence of coloring on the output screen can be suppressed and a high-quality image can be achieved.

### Fourth Embodiment

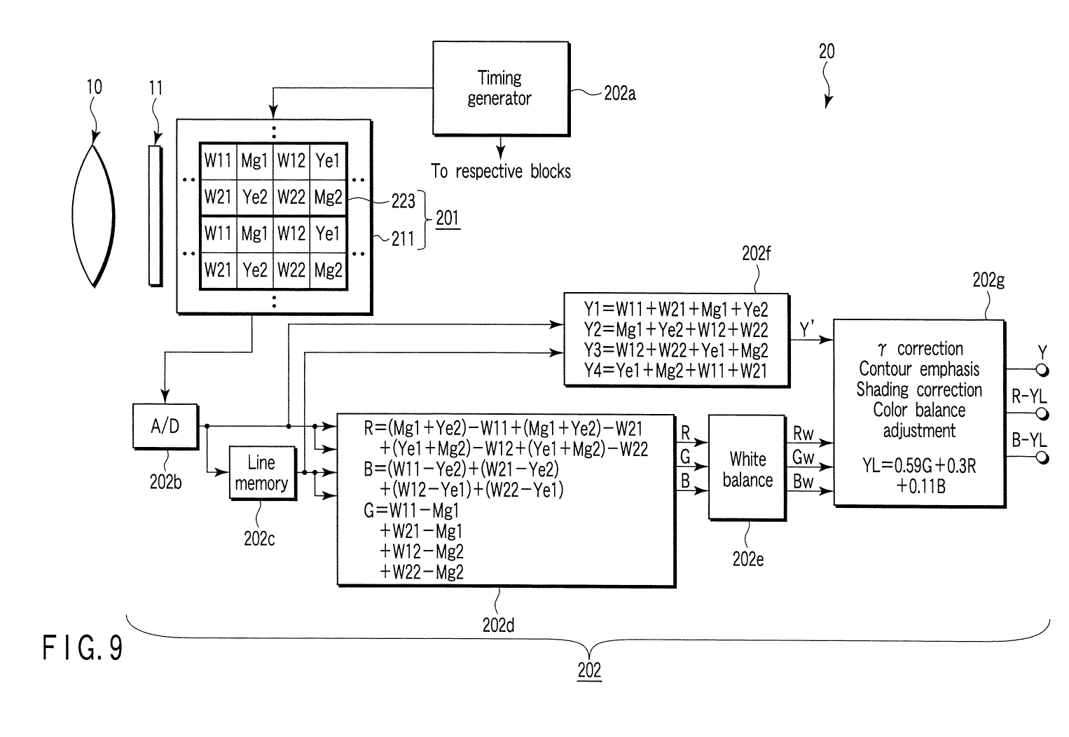

FIG. 9 shows the basic configuration of a one-chip camera using a CMOS type color image sensor (solid-state image sensing device) according to a fourth embodiment of this invention. In this example, a case wherein a photoelectric conversion cell is formed with the vertical-2-pixel/one-cell structure and a color filter of white/transparent (W), magenta (Mg), yellow (Ye) is used as a color filter is explained. Portions which are the same as those of FIG. 1 are denoted by the same reference symbols and the detail explanation thereof is omitted.

As shown in FIG. 9, in the present embodiment, the array of a color filter 223 is formed in a W-stripe/MgYe complete checkered form having the size corresponding to eight pixels of W, Mg, Ye in total area with two pixels in the vertical (row) direction and four pixels in the horizontal (column) direction. That is, in the case of the present embodiment, for example, W11 and W12 filters of a first color are respectively arranged on the first and third pixels in the horizontal direction of a first line of the color filter 223 in the vertical direction, an Mg1 filter of a second color is arranged on the second pixel in the horizontal direction and a Ye1 filter of a third color is arranged on the fourth pixel in the horizontal direction. Further, for example, W21 and W22 filters of the first color are respectively arranged on the first and third pixels in the horizontal direction of a second line thereof in the vertical direction, a Ye2 filter of the third color is arranged on the second pixel in the horizontal direction and an Mg2 filter of the second color is arranged on the fourth pixel in the horizontal direction. The color filters 223 with the above array are repeatedly arranged for each unit on the pixel area 211. In this case, the Mg1 filter, Ye1 filter and the Ye2 filter, Mg2 filter may be replaced in positions.

In a color separation circuit 202d of a signal processor 202, signals of two lines are added together to generate one horizontal video signal (R, G and B signals). That is, in the case of the present embodiment, an R signal is generated by adding signals of ((Mg1+Ye2)−W11+(Mg1+Ye2)−W21) and ((Ye1+Mg2)−W12+(Ye1+Mg2)−W22), a B signal is generated by adding signals of ((W11−Ye2)+(W21−Ye2)) and ((W12−Ye1)+(W22−Ye1)) and a G signal is generated by adding signals of (W11−Mg1), (W21−Mg1), (W12−Mg2) and (W22−Mg2). Thus, a signal difference between the lines of the respective signals of R, G and B can be suppressed even if a signal difference (sensitivity difference) occurs between the odd-numbered line and the even-numbered line of the photodiodes PD1, PD2, particularly, in the upper portion (or lower portion) of the pixel area 211.

In a luminance signal processing circuit 202f, signals of two lines are sequentially added for every four pixels of area with two pixels in the vertical direction and two pixels in the horizontal direction and a luminance control signal Y′ is finally generated. That is, in the case of the present embodiment, added signals Y1, Y2, Y3, Y4 are calculated by repeatedly performing the adding operations (arithmetic operations of W+W+Mg+Ye) of the signals while one pixel is horizontally shifted at one time. For example, the added signal Y1 is calculated by performing the adding operation (W11+W21+Mg1+Ye2) of the signals, the added signal Y2 is calculated by performing the adding operation (Mg1+Ye2+W12+W22) of the signals, the added signal Y3 is calculated by performing the adding operation (W12+W22+Ye1+Mg2) of the signals and the added signal Y4 is calculated by performing the adding operation (Ye1+Mg2+W11+W21) of the signals. Then, the luminance control signal Y′ is generated based on the added signals Y1, Y2, Y3, Y4.

Like the case of the first embodiment, when the above color filter 223 is used, a signal difference between the lines of the respective signals of R, G and B can be suppressed even if a signal difference (sensitivity difference) occurs between the odd-numbered line and the even-numbered line of the photodiodes PD1, PD2, particularly, in the upper portion (or lower portion) of the pixel area 211. Thus, occurrence of coloring on the output screen can be suppressed and a high-quality image can be achieved.

### Fifth Embodiment

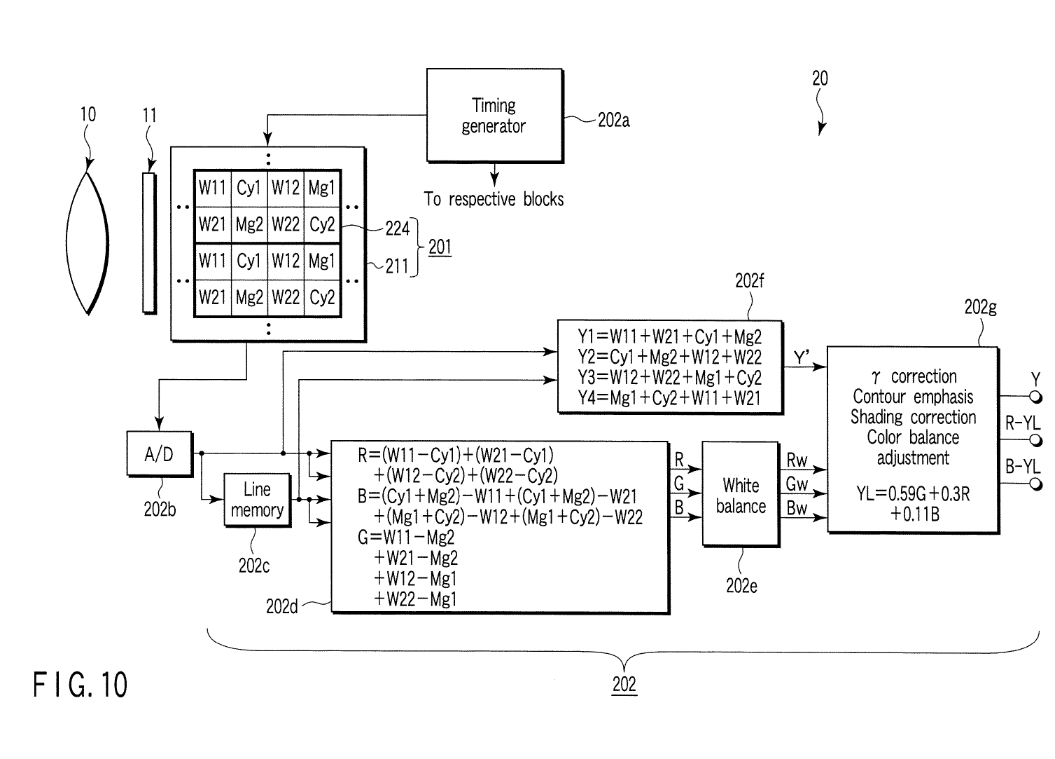

FIG. 10 shows the basic configuration of a one-chip camera using a CMOS type color image sensor (solid-state image sensing device) according to a fifth embodiment of this invention. In this example, a case wherein the photoelectric conversion cell is formed with the vertical-2-pixel/one-cell structure and a complementary color filter of white/transparent (W), cyan (Cy), magenta (Mg) is used as a color filter is explained. Portions which are the same as those of FIG. 1 are denoted by the same reference symbols and the detail explanation thereof is omitted.

As shown in FIG. 10, in the present embodiment, the array of a color filter 224 is formed in a W-stripe/CyMg complete checkered form having the size corresponding to eight pixels of W, Cy, Mg in total area with two pixels in the vertical (row) direction and four pixels in the horizontal (column) direction. That is, in the case of the present embodiment, for example, W11 and W12 filters of a first color are respectively arranged on the first and third pixels in the horizontal direction of a first line of the color filter 224 in the vertical direction, a Cy1 filter of a second color is arranged on the second pixel in the horizontal direction and an Mg1 filter of a third color is arranged on the fourth pixel in the horizontal direction. Further, for example, W21 and W22 filters of the first color are respectively arranged on the first and third pixels in the horizontal direction of a second line thereof in the vertical direction, an Mg2 filter of the third color is arranged on the second pixel in the horizontal direction and a Cy2 filter of the second color is arranged on the fourth pixel in the horizontal direction. The color filters 224 with the above array are repeatedly arranged for each unit on the pixel area 211. In this case, the Cy1 filter, Mg1 filter and the Mg2 filter, Cy2 filter may be replaced in positions.

In a color separation circuit 202d of a signal processor 202, signals of two lines are added together to generate one horizontal video signal (R, G and B signals). That is, in the case of the present embodiment, an R signal is generated by adding signals of ((W11−Cy1)+(W21−Cy1)) and ((W12−Cy2)+(W22−Cy2)), a B signal is generated by adding signals of ((Cy1+Mg2)−W11+(Cy1+Mg2)−W21) and ((Mg1+Cy2)−W12+(Mg1+Cy2)−W22) and a G signal is generated by adding signals of (W11−Mg2), (W21−Mg2), (W12−Mg1) and (W22−Mg1). Thus, a signal difference between the lines of the respective signals of R, G and B can be suppressed even if a signal difference (sensitivity difference) occurs between the odd-numbered line and the even-numbered line of the photodiodes PD1, PD2, particularly, in the upper portion (or lower portion) of the pixel area 211.

In a luminance signal processing circuit 202f, signals of two lines are sequentially added for every four pixels of area with two pixels in the vertical direction and two pixels in the horizontal direction and a luminance control signal Y′ is finally generated. That is, in the case of the present embodiment, added signals Y1, Y2, Y3, Y4 are calculated by repeatedly performing the adding operations (arithmetic operations of W+W+Cy+Mg) of the signals while one pixel is horizontally shifted at one time. For example, the added signal Y1 is calculated by performing the adding operation (W11+W21+Cy1+Mg2) of the signals, the added signal Y2 is calculated by performing the adding operation (Cy1+Mg2+W12+W22) of the signals, the added signal Y3 is calculated by performing the adding operation (W12+W22+Mg1+Cy2) of the signals and the added signal Y4 is calculated by performing the adding operation (Mg1+Cy2+W11+W21) of the signals. Then, the luminance control signal Y′ is generated based on the added signals Y1, Y2, Y3, Y4.

Like the case of the first embodiment, when the above color filter 224 is used, a signal difference between the lines of the respective signals of R, G and B can be suppressed even if a signal difference (sensitivity difference) occurs between the odd-numbered line and the even-numbered line of the photodiodes PD1, PD2, particularly, in the upper portion (or lower portion) of the pixel area 211. Thus, occurrence of coloring on the output screen can be suppressed and a high-quality image can be achieved.

### Sixth Embodiment

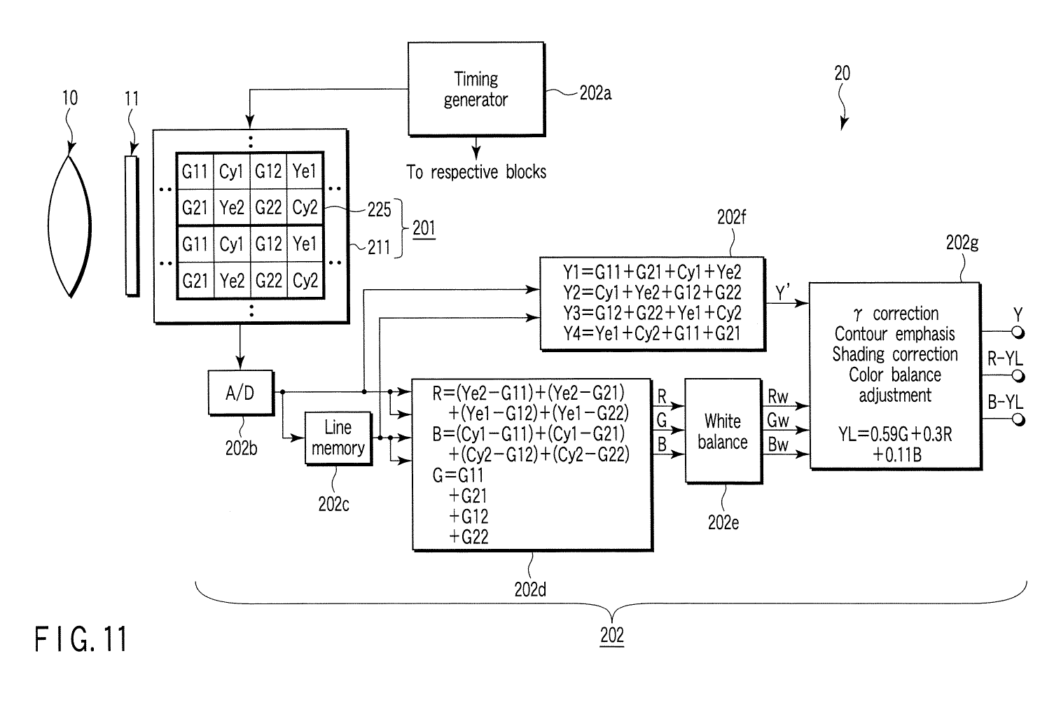

FIG. 11 shows the basic configuration of a one-chip camera using a CMOS type color image sensor (solid-state image sensing device) according to a sixth embodiment of this invention. In this example, a case wherein the photoelectric conversion cell is formed with the vertical-2-pixel/one-cell structure and a color filter of green (G), cyan (Cy), yellow (Ye) is used as a color filter is explained. Portions which are the same as those of FIG. 1 are denoted by the same reference symbols and the detail explanation thereof is omitted.

As shown in FIG. 11, in the present embodiment, the array of a color filter 225 is formed in a G-stripe/CyYe complete checkered form having the size corresponding to eight pixels of G, Cy, Ye in total area with two pixels in the vertical (row) direction and four pixels in the horizontal (column) direction. That is, in the case of the present embodiment, for example, G11 and G12 filters of a first color are respectively arranged on the first and third pixels in the horizontal direction of a first line of the color filter 225 in the vertical direction, a Cy1 filter of a second color is arranged on the second pixel in the horizontal direction and a Ye1 filter of a third color is arranged on the fourth pixel in the horizontal direction. Further, for example, G21 and G22 filters of the first color are respectively arranged on the first and third pixels in the horizontal direction of a second line thereof in the vertical direction, a Ye2 filter of the third color is arranged on the second pixel in the horizontal direction and a Cy2 filter of the second color is arranged on the fourth pixel in the horizontal direction. The color filters 225 with the above array are repeatedly arranged for each unit on the pixel area 211. In this case, the Cy1 filter, Ye1 filter and the Ye2 filter, Cy2 filter may be replaced in positions.

In a color separation circuit 202d of a signal processor 202, signals of two lines are added together to generate one horizontal video signal (R, G and B signals). That is, in the case of the present embodiment, an R signal is generated by adding signals of ((Ye2−G11)+(Ye2−G21)) and ((Ye1−G12)+(Ye1−G22)), a B signal is generated by adding signals of ((Cy1−G11)+(Cy1−G21)) and ((Cy2−G12)+(Cy2−G22)) and a G signal is generated by adding signals of G11, G21, G12 and G22. Thus, a signal difference between the lines of the respective signals of R, G and B can be suppressed even if a signal difference (sensitivity difference) occurs between the odd-numbered line and the even-numbered line of the photodiodes PD1, PD2, particularly, in the upper portion (or lower portion) of the pixel area 211.

In a luminance signal processing circuit 202f, signals of two lines are sequentially added for every four pixels of area with two pixels in the vertical direction and two pixels in the horizontal direction and a luminance control signal Y′ is finally generated. That is, in the case of the present embodiment, added signals Y1, Y2, Y3, Y4 are calculated by repeatedly performing the adding operations (arithmetic operations of G+G+Cy+Ye) of the signals while one pixel is horizontally shifted at one time. For example, the added signal Y1 is calculated by performing the adding operation (G11+G21+Cy1+Ye2) of the signals, the added signal Y2 is calculated by performing the adding operation (Cy1+Ye2+G12+G22) of the signals, the added signal Y3 is calculated by performing the adding operation (G12+G22+Ye1+Cy2) of the signals and the added signal Y4 is calculated by performing the adding operation (Ye1+Cy2+G11+G21) of the signals. Then, the luminance control signal Y′ is generated based on the added signals Y1, Y2, Y3, Y4.

Like the case of the first embodiment, when the above color filter 225 is used, a signal difference between the lines of the respective signals of R, G and B can be suppressed even if a signal difference (sensitivity difference) occurs between the odd-numbered line and the even-numbered line of the photodiodes PD1, PD2, particularly, in the upper portion (or lower portion) of the pixel area 211. Thus, occurrence of coloring on the output screen can be suppressed and a high-quality image can be achieved.

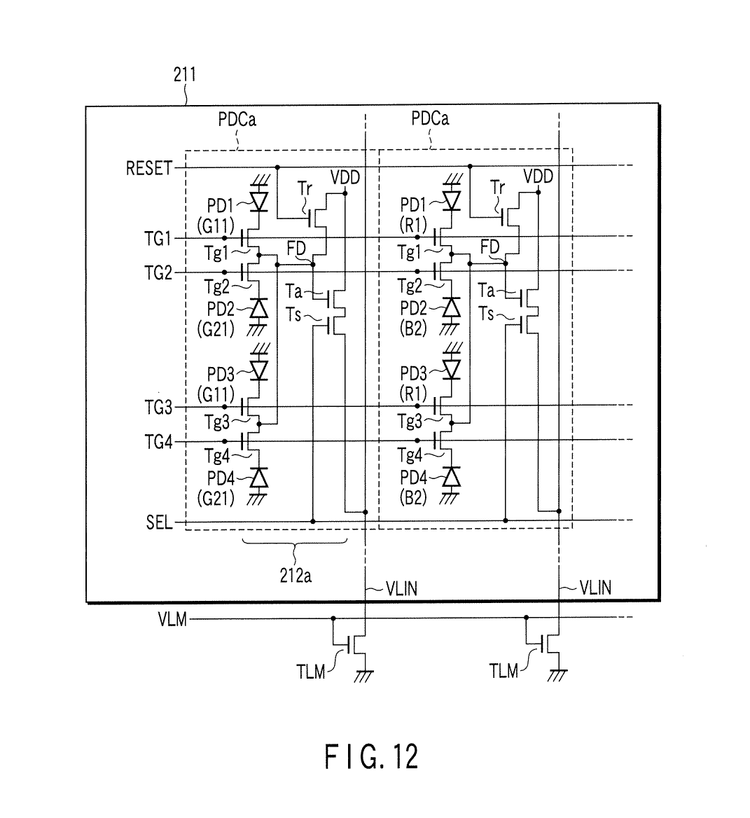

In each of the embodiments described above, a case wherein the photoelectric conversion cell is formed with the vertical-2-pixel/one-cell structure is explained. However, the photoelectric conversion cell is not limited to the above case and, for example, as shown in FIG. 12, the photoelectric conversion cell can be applied to the vertical-4-pixel/one-cell structure. The general layout of the photoelectric conversion cell PDC of the vertical-4-pixel/one-cell structure is approximately equal to the photoelectric conversion cell PDC of the vertical-2-pixel/one-cell structure. This is because a photoelectric conversion cell PDCa of the vertical-4-pixel/one-cell structure can be easily configured by mutually connecting contacts of the detectors FD of two photoelectric conversion cells PDC of the vertical-2-pixel/one-cell structure arranged in the vertical direction via Al wirings, for example. That is, the photoelectric conversion cell PDCa of the vertical-4-pixel/one-cell structure is configured by seven transistors Ta, Ts, Tr, Tg1, Tg2, Tg3, Tg4 and four photodiodes PD1, PD2, PD3, PD4.

Particularly, when in total area with fore pixels in the vertical direction and fore pixels in the horizontal direction is used, the signal-to-noise (S/N) ratio can be further improved by forming the color separation circuit 202d of the signal processor 202 to have four (2n) line inputs and processing input signals.

Further, this invention can be applied to a photoelectric conversion cell of one-pixel/one-cell structure. In this case, occurrence of coloring due to chromatic aberration (variation in the refractive index (incident angle) due to a difference in the wavelength) of the optical lens 10 can be suppressed.

Further, in each of the above embodiments, a case wherein the image sensor 20 is configured by use of one chip by taking the one-chip camera as an example is explained. However, the image sensor is not limited to this case and an image sensor with a so-called multi-chip structure having the solid-state image sensing device 201 and the signal processor 202 configured on different chips can be used.

In addition, this invention is not limited to the one-chip camera and, for example, this invention can also be applied to sensor modules (small modules) for mobile telephones with optical lenses.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A solid-state image sensing device comprising:
a plurality of light receivers two-dimensionally arranged on a semiconductor substrate and each used as a single pixel;
a plurality of condensers respectively arranged above the plurality of light receivers;
a plurality of color filters respectively arranged between the plurality of light receivers and the plurality of condensers, each of the plurality of color filters being configured to have two pixels in a vertical direction and four pixels in a horizontal direction of the plurality of light receivers used as one unit area, a first color being arranged on first and third pixels in the horizontal direction, a second color being arranged on a second pixel of the horizontal direction, a third color being arranged on a fourth pixel in the horizontal direction of a first line in the vertical direction, the first color being arranged on first and third pixels in the horizontal direction, the third color being arranged on a second pixel in the horizontal direction and the second color being arranged on a fourth pixel in the horizontal direction of a second line thereof in the vertical direction; and
a signal processor which generates one horizontal video signal based on output signals of 2n (n is a natural number) lines in the vertical direction read from the plurality of light receivers.

2. The solid-state image sensing device according to claim 1, wherein every 2n (n is a natural number) light receivers arranged adjacent in the vertical direction among the plurality of light receivers configure one photoelectric conversion cell.

3. The solid-state image sensing device according to claim 2, wherein each of the photoelectric conversion cells includes read gates which read signal charges by use of the 2n light receivers and a detector which converts the signal charges read by the read gates into a voltage value.

4. The solid-state image sensing device according to claim 3, wherein each of the photoelectric conversion cells has the two light receivers arranged adjacent in the vertical direction with the detector set at the center and the read gates arranged in parallel in the horizontal direction between the detector and the two light receivers.

5. The solid-state image sensing device according to claim 4, wherein parts of the read gates are arranged to extend to positions near central portions of condensing areas of the two light receivers.

6. The solid-state image sensing device according to claim 3, wherein each of the photoelectric conversion cells has the two light receivers arranged adjacent in the vertical direction with the read gates arranged in an oblique direction with respect to the two light receivers.

7. The solid-state image sensing device according to claim 6, wherein parts of the read gates are arranged to extend to positions near central portions of condensing areas of the two light receivers.

8. The solid-state image sensing device according to claim 1, wherein the first color is green, the second color is one of red and blue and the third color is one of blue and red in the plurality of color filters.

9. The solid-state image sensing device according to claim 1, wherein the first color is transparent, the second color is one of cyan and yellow and the third color is one of yellow and cyan in the plurality of color filters.

10. The solid-state image sensing device according to claim 1, wherein the first color is transparent, the second color is one of red and blue and the third color is one of blue and red in the plurality of color filters.

11. The solid-state image sensing device according to claim 1, wherein the first color is transparent, the second color is one of magenta and yellow and the third color is one of yellow and magenta in the plurality of color filters.

12. The solid-state image sensing device according to claim 1, wherein the first color is transparent, the second color is one of cyan and magenta and the third color is one of magenta and cyan in the plurality of color filters.

13. The solid-state image sensing device according to claim 1, wherein the first color is green, the second color is one of cyan and yellow and the third color is one of yellow and cyan in the plurality of color filters.

14. The solid-state image sensing device according to claim 1, wherein light emitted from an image sensing optical system for a camera is made incident on the plurality of light receivers via the plurality of condensers and plurality of color filters.

15. The solid-state image sensing device according to claim 1, wherein the color filters and condensers are arranged above the light receivers corresponding in position to peripheral portions of a pixel area configured by the plurality of light receivers while the positions thereof are shifted from directly above the light receivers in a direction of incident light.
